(19) United States
(12) Patent Application Publication
(10) Pub. No.: US 2021/0352468 A1
(43) Pub. Date: Nov. 11, 2021

(54) ACCESS METHOD IN 5G SYSTEM

(71) Applicant: Dongguan University of Technology, Guangdong (CN)

(72) Inventors: Miaona HUANG, Guangdong (CN); Bin REN, Guangdong (CN)

(73) Assignee: Dongguan University of Technology, Guangdong (CN)

(21) Appl. No.: 17/277,303

(22) PCT Filed: Nov. 16, 2018
(86) PCT No.: PCT/CN2018/115783

§ 371 Date: Mar. 18, 2021

(30) Foreign Application Priority Data
Oct. 30, 2018 (CN) 201811278897.9

(51) Int. Cl. H04W 8/26; H04W 74/00

(52) U.S. Cl. CPC H04W 8/26; H04W 74/002

(57) ABSTRACT

The invention relates to an access method in a 5G system. For user equipments: based on a virtual SIM technology and ID sharing, the user equipments can modify their ID dynamically and the user equipments sharing the same ID can access a network based on a non-orthogonal multiple access technology. For the network: a signaling load of the access network can be reduced due to grant-free and non-orthogonal technologies, meanwhile, the user equipments with the same ID will be allocated with the same radio bearer, when mass equipments are accessed at the same time, it can effectively reduce a signaling overload of the access network and a core network, improve a resource utilization efficiency of the network equipment, and ensure a normal access of users for data transmission.

### TECHNICAL FIELD

The present invention relates to the field of a mobile communication technology, and more particularly, to an access method in a 5G system.

### BACKGROUND

With a transformation of wireless communication from traditional real-time voice services to data services, the number of access terminals and a transmission rate of a wireless communication system has increased geometrically. In order to meet an explosive demand of the wireless communication, compared with 4G, next-generation 5G communication network needs to support wider range of service types and provide better coverage and high-quality services, such as higher transmission rates and lower end-to-end delays. Facing different needs of various service types, the next-generation 5G network will mainly divide all service types into three types of application scenarios. The first is eMBB (evolved mobile broadband) for large traffic and large bandwidth. The second is called uRLLC (ultra reliable low latency communication), which is mainly for autonomous driving and factory assembly line control. The third is a service with a large number of sensors for Internet of Things, called mMTC (massive machine type communications). In order to support requirements of the above-mentioned different services at the same time, 5G will adopt a network slicing based on NFV/SDN (network function virtualization, Software defined network) and other technologies. The network slicing is logically independent logical sub-networks. Each sub-network, also called slicing runs on the same hardware platform based on NFV/SDN technology, but each slicing is independent of each other. According to needs of the sensors, each slicing has an independent life cycle, QoS guarantee mechanism, security, SLA (Service level agreement) and so on.

An existing LTE system is mainly divided into a radio access network and a core network. For the future evolution of wireless network to 5G, this architecture will remain unchanged, but corresponding functions will be migrated. For example, in order to meet a requirement of extremely low latency, some functional modules of the core network will be moved down to the access network.

For mMTC service, the future 5G system needs to meet the number of accesses per square meter of 1,000,000, mainly for IoT (Internet of Things) sensors. Characteristics of mass connection services are as follows:

(1) Large number of connections;

(2) Each transmission is a small data service;

(3) The service is mainly uplink, only a small amount of downlink service;

(4) The sensors are generally in a static state or moving at a low speed;

(5) Constrained by cost and size, sensors are generally in a low power consumption state and are only suitable for applications with low algorithm complexity.

As mentioned above, the existing communication system faces massive connection services, and the main bottleneck comes from a control plane. For sensor services, a capacity demand on a data plane is relatively low. For example, a demand for ordinary sensors is in Kbps order. Even in a face of millions of connections per square kilometer, the current system or the future 5G can satisfy. As a large number of sensors are connected at the same time, an increase of signaling on the control plane will cause a huge burden on the system. For the access network (RAN), for each service transmission of each sensor, the control plane needs to perform a series of processes such as establishing uplink/downlink synchronization, RRC connection, registration, authentication, and authorization. For the core network (Core Network), it is necessary to complete processes such as authentication, assigning IP, and establishing a bearer for each sensor transmission. For each sensor bearer, the core network needs to retain connection status information for it, even if it is in its dormant state without service transmission. Due to the large coverage area of the core network, for example, there may be only one core network in the entire South China region, which will cause a huge signaling burden to the system. These massive connections of small data transmission service not only lose system performance, but also reduce system resource utilization rate. In the face of mMTC service, corresponding improvements are needed to the access network and core network of the existing system, mainly to reduce the signaling requirements of the system control plane and improve the utilization of system resources.

Aiming at a large number of connected sensors, Xu Li et al. proposed a virtual gateway-based solution in a literature “Engineering Machine-to-Machine Traffic in 5G”. Its technical characteristic is based on service or time and space relevance, a virtual GW (Virtual GateWay) node is used to aggregate small data packets of a large number of sensor services. This can partially reduce the signaling of the core network and improve the utilization of equipment. The disadvantage is that a control plane signaling load of the access network is not considered, and an access burden on the control plane cannot be reduced. For example, in the case of a large number of connections, there is a risk of collision and congestion of the control plane of the RAN during random access, and a solution is based on optimization theory, an algorithm is relatively complex, and it is not suitable for low-power sensor services.

For a large number of connected sensors, based on the LTE system, the existing technology proposes an IMSI sharing scheme. Through multiple sensors sharing the IMSI, the core network will assign the same bearer to all sensors sharing the same IMSI, and all sensors upload data through the same bearer established. For the core network, different sensors are regarded as terminals with constantly changing locations, but only the service status information of the terminals is maintained on the core network. At the same time, for the core network, it is necessary to add a MTC-IWF network element between the final data server (MTC-Server) and the core network to perform the final translation of a sensor ID. The advantage of this solution is that it can greatly reduce the amount of system connection status information on the core network side and improve the system efficiency of the core network. However, as this solution is mainly to solve the signaling burden of the LTE core network when facing a large number of connected sensors, the access network is not considered. In addition, the sensors sharing the IMSI are relatively fixed, which is not suitable for scenarios with large service changes; and it needs to add an additional network element to the core network. Finally, as its idea is based on being compatible with the current LTE network, there are relatively few considerations for applications in the future 5G network, and its solution is relatively limited.

### SUMMARY

A solution of the present invention is based on next generation 5G network architecture. Considering that a use of Soft SIM will become a trend, the solution uses sensors based on soft SIM card for ID sharing and modification, and considers a use of grant-free transmission of an access network to reduce a control plane signaling burden of the access network. The grant-free transmission method is proposed in 5G, which is mainly used to simplify a data transmission method based on a random access process in traditional 4G LTE, and reduce the number of control signaling when a large number of sensors are accessing. However, as a large number of sensors are connected at the same time without considering a resource allocation, it will cause a large number of sensors to collide during random access. In order to solve the collision problem when a large number of sensors perform grant-free transmission at the same time, the present invention proposes a solution based on non-orthogonal multiple access, which can improve an access success probability of a large number of access terminals. For a core network, through a machine learning solution, sensors with similar services are classified first, and sensors classified as the same type of service use the same SIM card, that is, the same ID, thereby reducing the signaling burden of the core network. The advantage of the solution of the present invention is that it can reduce a signaling plane load of the access network and the core network, and considers dynamics of sensor services; in addition, the complexity of the solution is low, which is suitable for the requirements of the sensor services.

In order to achieve the above objectives, the technical solutions adopted are as follows.

An access method in a 5G system is provided. For the access network, a soft SIM card is used to share ID. Sensors can dynamically modify the ID of the SIM card. All sensors sharing the ID will have the same ID, and then access based on grant-free transmission scheme of non-orthogonal multiple access. For the core network, all sensors with the same ID will be assigned the same data bearer.

Preferably, a specific process for the sensors to modify the ID of the SIM card is as follows.

S1. the sensors determine whether the ID of the SIM card needs to be modified according to a current service. If the current service has not changed, or the network has not notified it to modify the ID, there is no need to modify the ID of its SIM card. If it is changed, it needs to be modified, and then step S2 is executed.

S2. according to the current service and historical service conditions, the sensors use convex optimization, machine learning or clustering method to classify the current services of the sensors. Then, according to a result of classification, when the services of the sensors are classified into the same category, the sensors are assigned the same ID of the SIM card.

### BRIEF DESCRIPTION OF THE DRAWINGS

FIG. 1 is a schematic diagram of 5G network architecture.

FIG. 2 is a schematic diagram of a shared ID access of a soft SIM.

FIG. 3 is a schematic diagram of an ID assignment and modification.

FIG. 4 is a flow chart of a sensor classification.

FIG. 5 is a schematic diagram of a Q-learning algorithm based on a fully connected neural network.

FIG. 6 is a schematic diagram of a centralized ID assignment and modification.

FIG. 7 is a schematic diagram of a distributed ID assignment and modification.

FIG. 8 is a schematic diagram of a multi-user grant-free data transmission.

FIG. 9 is a schematic diagram of a non-orthogonal multiple access in a power domain.

### DETAILED DESCRIPTION

The drawings are for illustrative purposes only and cannot be construed as limiting the patent.

The present invention is further described with reference to the accompanying drawings and examples.

### Example 1

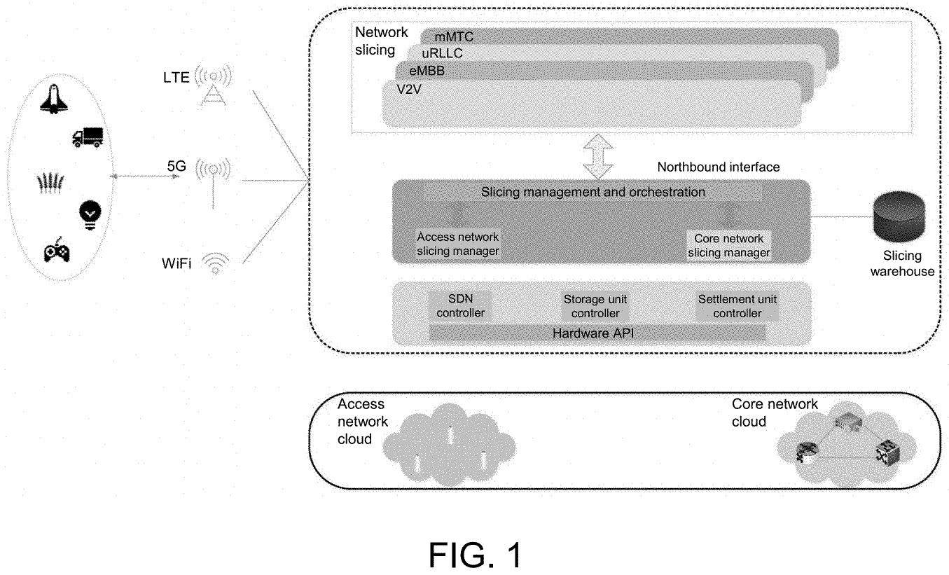

A solution of the present invention is based on next generation 5G network architecture, and 5G will establish a logical network slicing based on NFV/SDN, and its block diagram is shown in FIG. 1. A bottom layer is a basic hardware platform, including an access network and a core network. In 5G, both the access network and the core network adopt cloud architecture, that is, an implementation of the access network and the core network is based on cloud technology. Above the hardware platform is a software virtualization layer, including various controllers, such as a SDN controller, a storage controller, and a computing controller. These controllers control an underlying physical hardware through a dedicated interface API. Above this is a slicing management and orchestration module, which customizes various network slicings according to needs of sensors, and stores common slicing modules in a slicing warehouse to accelerate establishment and adjustment of the network slicings. In this layer, there are corresponding slicing controllers for the access network and the core network.

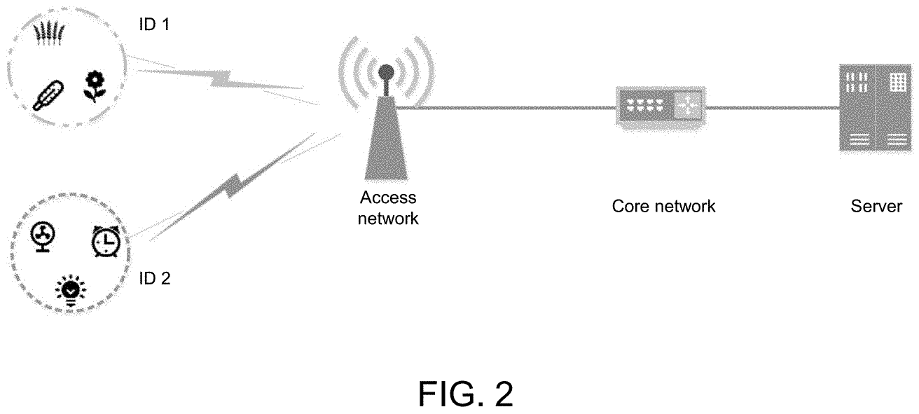

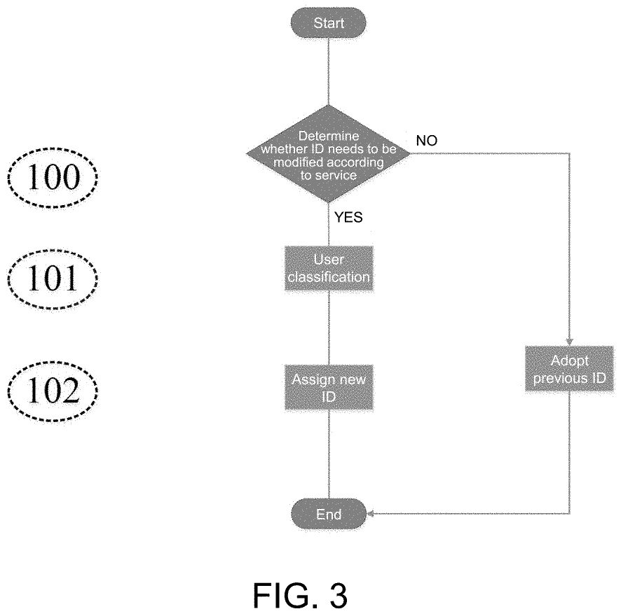

The next-generation 5G network needs to provide 1,000,000 connections per square meter for mMTC scenario. Faced with a large number of sensors simultaneously initiating connections, existing network has a risk of signaling storms of both the access network and the core network. In order to prevent network congestion, as shown in FIG. 2, the present invention proposes a grant-free transmission scheme based on a shared ID of a soft SIM card. For the access network, the soft SIM card is used to share an ID. The advantages of sharing the ID based on the soft SIM are as follows. First, the ID can be dynamically modified by a sensor or a network, without manual replacement of a physical SIM card. As shown in FIG. 3, the sensor changes the ID of the soft SIM card according to a direct service need, and all sensors sharing the ID will have the same ID. Second, for the network, all sensors with the same ID will be assigned the same data bearer, which can improve resource utilization of a sensor network. Since the sensor can change the ID according to the service, and how to change it will become a main concern, the assignment and modification of the sensor ID uses a process shown in FIG. 3 as follows.

Step 100: the sensor determines whether the ID needs to be modified according to a current service, or modify the ID according to a command from the network. If the current service has not changed, there is no need to modify the ID. If it is changed, it needs to be modified. Or there is a new requirement, and the ID needs to be modified. Of course, there are other situations, such as changes in the network environment, etc.

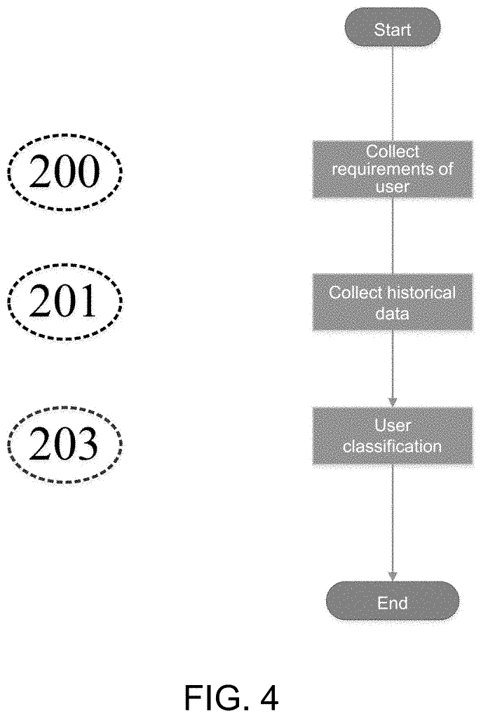

Step 101: the sensor classifies the service of the sensor according to a historical data of the current service. A classification method can use convex optimization, decision tree, k-Nearest Neighbors (kNN) algorithm or machine learning method, such as linear regression, Q-learning method or clustering method. Further details are shown in a flow chart of FIG. 4.

As shown in FIG. 4, process 200 is to collect a service requirement of the sensor, such as whether a data transmitted by the sensor is to a new server or to an old server; or the data previously transmitted is used for forest fire alarm, and now it is changed to report air quality.

Process 201: to collect historical data of user equipments, a database, and sensors record a current or previous period of time of the sensors' services, and ID information corresponding to different services of the sensors, etc. This is mainly to prepare a sensor classification algorithm so that an ID assignment strategy is more reasonable and effective.

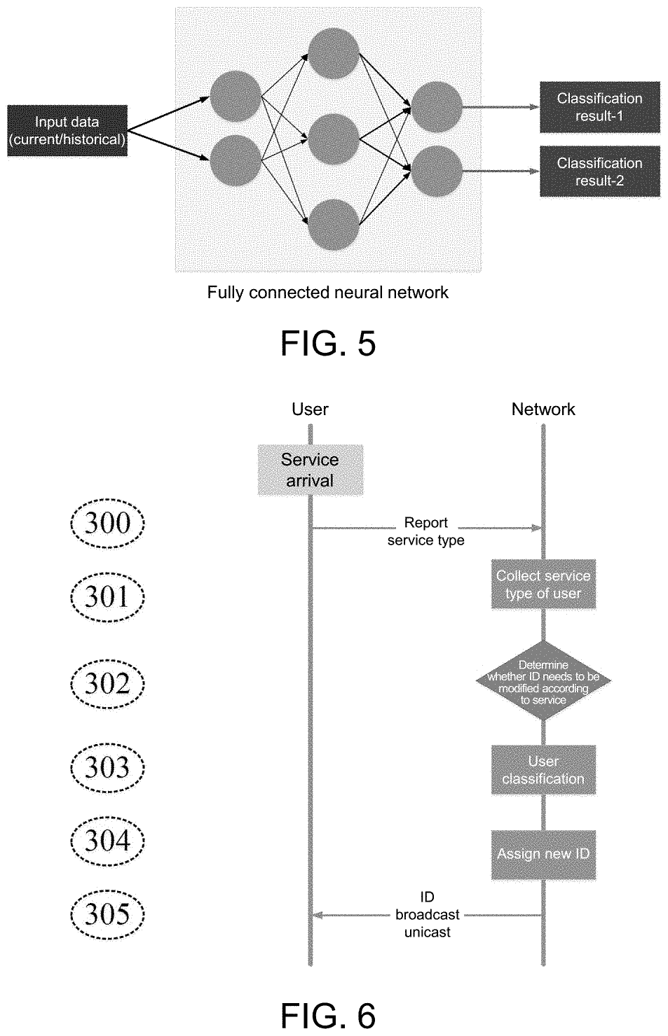

Process 202: sensor classification: the classification method can be based on a traditional classification algorithm, or Q-Learning of a fully connected neural network in machine learning and Q-learning algorithms. A specific implementation process is shown in FIG. 5.

For this network, input current and historical data, and the neural network uses an enhanced learning algorithm to output Q-Value singly, which corresponds the classification result of each sensor, as shown in FIG. 5.

Step 203: all the sensors classified into one category are assigned the same ID, and each sensor maintains an ID database, or broadcasts the database to the sensor through the network.

If the above algorithms occur in the sensor, it is distributed. If they occur in a base station, it is centralized. The characteristics and processes of the centralized and distributed algorithms are described below.

(1) Centralized:

Before step 300, the sensor uploads a service type according to the service to be uploaded. A flow of assignment modification is shown in FIG. 6.

Step 300: the sensor reports a current service type, a server to be connected to the sensor, an upload period and other parameters to the network.

Step 301: the network collects and stores covered sensors' service types.

Step 302: the network determines whether to modify the ID according to the current service type and a historical service type.

Step 303: the sensors are classified; input parameters of the classification algorithm may include, for example, the service type of the sensor, or the type of the server to which it belongs, or a correlation in time and space, etc.

Step 304: the ID is assigned according to the type of assignment.

Step 305: the ID of the sensor is broadcasted or unicasted to the sensor. At this time, the sensor that does not need to modify the ID can simply ACK the information or do not do any broadcast or unicast. The sensor that needs to modify the ID needs to broadcast its new ID.

(2) Distributed:

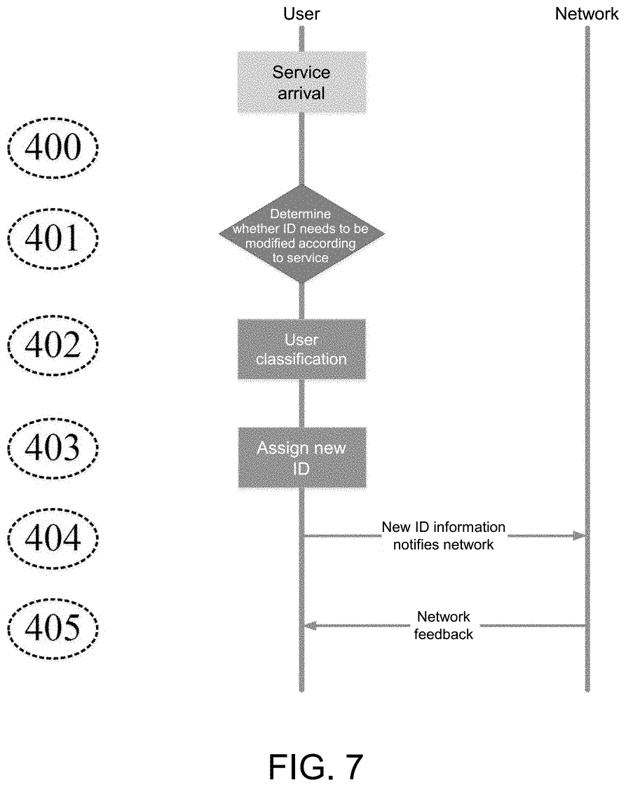

A difference from the centralized type is that step 401 to step 403 are performed in the sensor. At the same time, if the sensor modifies the ID, it needs to notify the network of the new ID, and then perform data transmission after receiving a confirmation from the network. A flow of assignment modification is shown in FIG. 7.

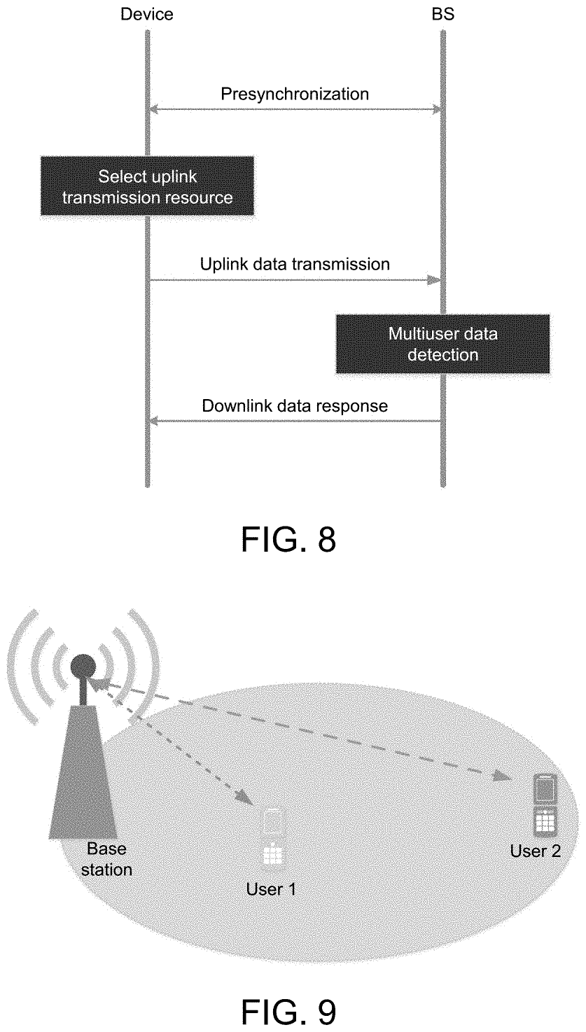

After the sensor obtains the ID, it will perform random access. Since there may be more users with the same ID, in order to reduce a collision probability of the sensors' random access, the present invention adopts a grant-free transmission scheme based on non-orthogonal multiple access. An access process is shown in FIG. 8. The orthogonal multiple access can be orthogonal multiple access in a power domain or orthogonal multiple access in a code domain. A specific scheme is shown in FIG. 9. The base station pairs sensors in the coverage cell, for example, sensor 1 and sensor 2 are paired, and the pairing is based on the distance between the sensor and the base station. In an actual system, due to a dense deployment of sensors, such pairings can always be found. The paired sensors can use different powers, but the same time-frequency resources are used for data transmission with the base station, and the base station demodulates the sensor data according to a method of serial interference cancellation (successive interference cancellation). The advantage of this method is that the sensor can transmit data in the same time-frequency resource, and saving resources. The present invention uses non-orthogonal multiple access to avoid collisions during random access of sensors. In a traditional method, the base station cannot distinguish when the sensors use the same time-frequency resource to send the same preamble, which will lead to longer user access time and lower efficiency. Based on a NOMA method and combined with the grant-free transmission, the sensor can directly send data, which not only saves resources, but also improves access efficiency. Of course, what is introduced here is the non-orthogonal multiple access in the power domain, and the orthogonal multiple access in the code domain is similar and will not be repeated.

It will be apparent that the above-described embodiments of the present invention are merely illustrative of the present invention and are not limiting embodiments of the present invention. For a person of ordinary skill in the art, other different forms of changes or changes may be made on the basis of the above description. All embodiments need not and cannot be exhaustive here. Any modifications, equivalent substitutions and improvements made within the spirit and principles of the invention shall be included within the scope of the claims of the invention.

1. An access method in a 5G system, for users, a soft SIM card sharing an ID is adopted, and user equipments can dynamically modify the ID of the soft SIM card, all the user equipments sharing the ID will have the same ID, and then access a network based on a grant-free transmission scheme of non-orthogonal multiple access; and for the network, a control plane signaling burden of the access network is reduced by a grant-free orthogonal access mode, and all the user equipments with the same ID will be assigned the same data bearer in a core network.

2. The access method in the 5G system according to claim 1, wherein a specific process for the user equipments can dynamically modify the ID of the soft SIM card is as follows:
S1. the user equipments determine whether the ID of the soft SIM card needs to be modified according to a current service; if the current service has not changed, there is no need to modify the ID of the soft SIM card; and if the current service is changed, the ID of the soft SIM card needs to be modified; and then step S2 is executed; and
S2. according to the current service and a historical service conditions, the user equipments use convex optimization method, machine learning method of artificial intelligence or clustering method to classify the current services of the sensors; and then, according to a result of classification, when the services of the user equipments are classified into the same category, the user equipments are assigned the same ID of the soft SIM card.
